(19) United States
(12) Patent Application Publication
(10) Pub. No.: US 2014/0067634 A1
(43) Pub. Date: Mar. 6, 2014

(54) FINANCIAL GOAL VISUALIZATION SYSTEM

(71) Applicants: James Brett Sowder, Austin, TX (US); Frank Anthony Nuzzi, Pflugerville, TX (US)

(72) Inventors: James Brett Sowder, Austin, TX (US); Frank Anthony Nuzzi, Pflugerville, TX (US)

(73) Assignee: EBAY INC., SAN JOSE, CA (US)

(21) Appl. No.: 13/601,768

(22) Filed: Aug. 31, 2012

(51) Int. Cl. G06Q 40/00

(52) U.S. Cl. 705/35

(57) ABSTRACT

A method for visualizing a financial goal includes receiving a selection of a financial goal from a user device of a user over a network. The financial goal includes a plurality of financial sub-goals, each of which is associated with a different image in a database. A plurality of first financial data is retrieved from user accounts of the user, and a first financial goal status is determined using the first financial data. An image for each financial sub-goal of the financial goal is provided based on the first financial goal status in order to display a storyboard having a plurality of images for visualizing progress related to the financial goal on a display device. As the financial goal status changes according to financial data retrieved from the users accounts, the image displayed for may financial sub-goal may be changed, visually indicating the users progress towards their financial goals.

### BACKGROUND

1. Field of the Invention

The present invention generally relates to planning and saving for financial goals and more particularly to a financial goal visualization system.

2. Related Art

Finances can be hard to manage, and financial goals are often only realizable after a significant period of time which is often not immediate enough to achieve the financial goal without deviating somewhere along the way. Furthermore, those deviations may not be recognized, or their consequences may not be clear with respect to the financial goals they affect. As a result, financial goals are often nonspecific with regard to the amount of money and time needed to achieve them, and are often not achieved due to the non-specificity of the financial goals and the inability to determine whether actions taken keep the financial goal on track.

Thus, there is a need for an improved system to help in planning and saving for financial goals.

### BRIEF DESCRIPTION OF THE FIGURES

FIG. 1 is a flow chart illustrating an embodiment of a method for visualizing a financial goal;

FIG. 2 is a screenshot illustrating an embodiment of a user device displaying a financial goal selection page;

FIG. 3 is a screenshot illustrating an embodiment of a user device displaying a first financial goal visualization page;

FIG. 4 is a screenshot illustrating an embodiment of a user device displaying a first financial goal savings plan page;

FIG. 5 is a screenshot illustrating an embodiment of a user device displaying a second financial goal visualization page;

FIG. 6 is a screenshot illustrating an embodiment of a user device displaying a second financial goal savings plan page;

FIG. 7 is a screenshot illustrating an embodiment of a user device displaying a third financial goal visualization page;

FIG. 8 is a screenshot illustrating an embodiment of a user device displaying a third financial goal savings plan page;

FIG. 9 is a screenshot illustrating an embodiment of a user device displaying a financial goals progress page;

FIG. 10 is a screenshot illustrating an embodiment of a user device displaying an updated financial goals progress page relative to the financial goals progress page illustrated in FIG. 9;

FIG. 11 is a screenshot illustrating an embodiment of a user device displaying a financial goal progress page;

FIG. 12 is a schematic view illustrating an embodiment of a networked system;

FIG. 13 is a schematic view illustrating an embodiment of a computer system; and

FIG. 14 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for visualizing financial goals. Financial goals are selected, provided by, or provided to a user, and may include the retrieval of financial goal details from the user that allow a plurality of financial sub-goals and financial goal statuses to be determined. For example, an education financial goal may be selected or provided, financial sub-goals may be determined for the education financial goal based on financial goal details that include the user having two children of relatively young age, and the financial goal statuses may be related to the amount of money required to send each of the children to different types of schools. Images are then associated with the financial sub-goals, and may be provided by the user to personalize the visualization of the financial goal. For example, the images may include images of graduating students, images of different schools, etc. Financial data for the user is then periodically retrieved and used to determine a financial goal status for the financial sub-goals of the financial goal, and the image for each financial sub-goal is displayed to the user based on that financial goal status. For example, if the user has saved enough for one of his children to attend a particular school, the images displayed may include a student graduating and an image of that particular school, while if the user has not saved enough for a child to attend the particular school, the image of the student graduating may not be displayed and the image of a school that the user can afford for the child may be displayed. The system and method allow a user to visualize a financial goal and the progress towards that financial goal using images that may be personalized to the user in order to have more impact on the user when the user is reviewing their progress towards the financial goal.

As a result, the system and method of the present disclosure provides a visual way to approach the problem of saving for financial goals, as a user may associate subsets of images with different financial goals, and the user will be presented with an image selected from those subsets that allows the user to visualize the status of each financial goal and their progress toward them. In an embodiment, images may be provided as storyboards that fill up with images, or have images taken off the storyboard, depending on the spending behavior of the user.

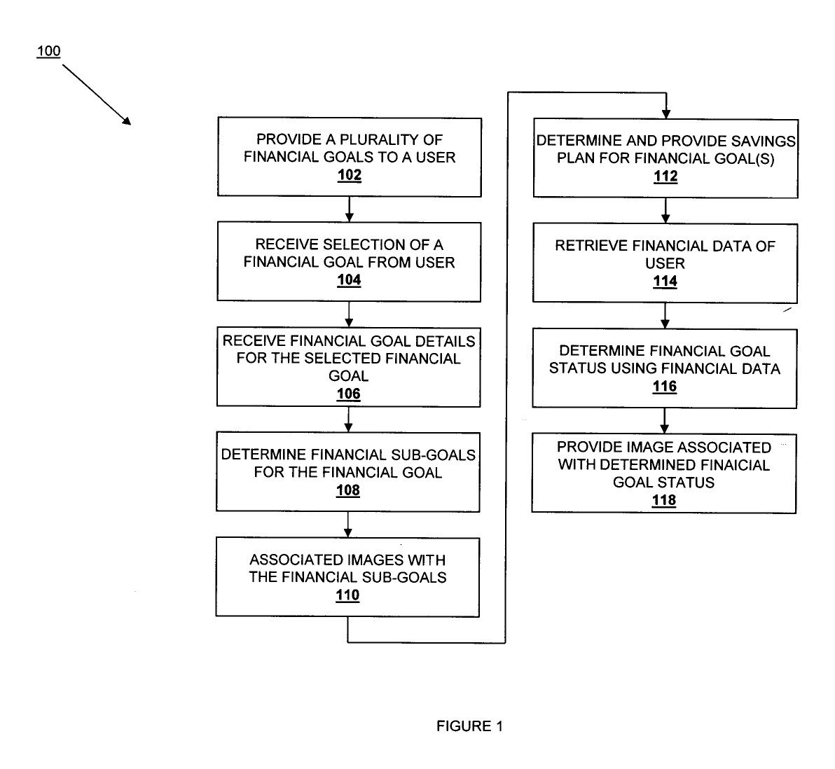

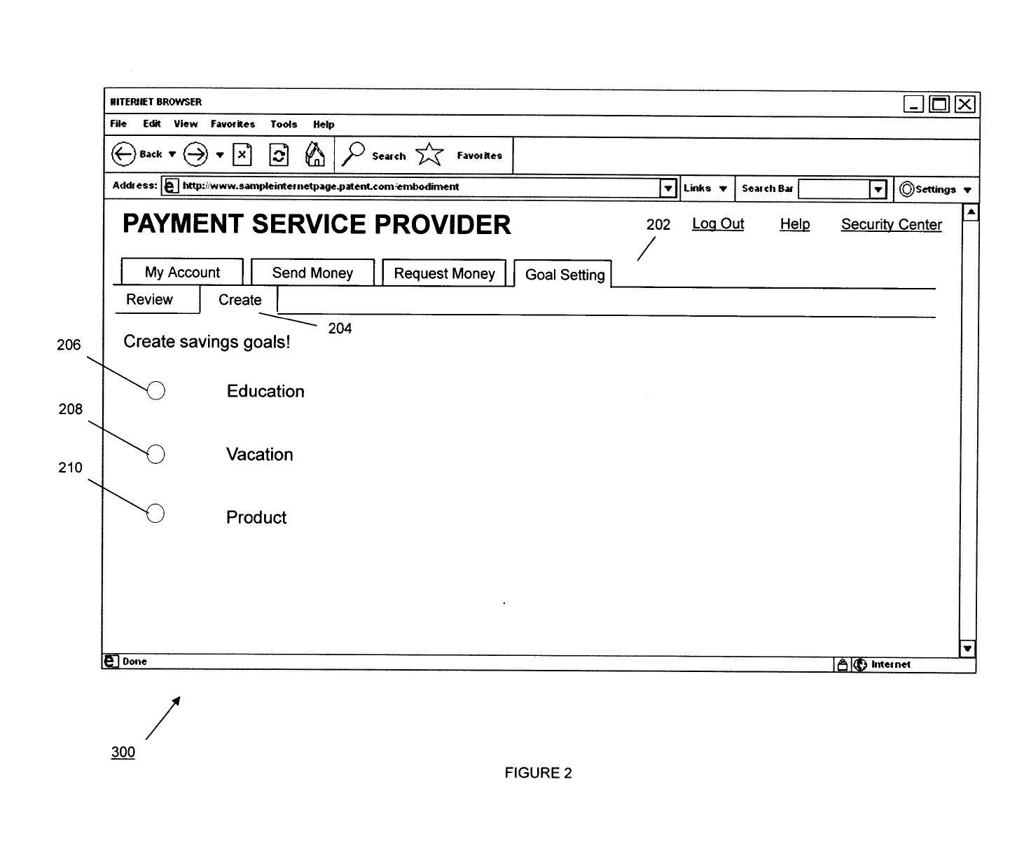

Referring now to FIGS. 1 and 2, a method 100 for visualizing a financial goal is illustrated. In the embodiment of the method 100 described below, account providers provide users with user accounts, and a user may use the user accounts to fund payments for purchases made from a payee. In another embodiment, a payment service provider such as, for example, PayPal, Inc. of San Jose, Calif. assists in the making of payments from the user to the payee by transferring funds from user accounts to a payee account of the payee. However, these embodiments are meant to be merely exemplary, and one of skill in the art will recognize that a variety of modifications may be made to the financial goal visualization system discussed below without departing from the scope of the present disclosure. In the financial goal visualization system discussed below, a financial goal visualization system provider device performs a variety of actions to allow a user to visualize their financial goals. The financial goal visualization system provider that uses that financial goal visualization system provider device may include the account provider, a payment service provider, and/or any other entity that may act as a financial goal visualization system provider by performing the actions discussed below.

The method 100 begins at block 102 where a plurality of financial goals may be provided to a user. In an embodiment, the financial goal visualization system provider device may include a plurality of predetermined financial goals that may be applicable to a variety of different users and that are stored in the device, and at block 102 the device may send a plurality of the financial goals over the network to a user device to provide the plurality of financial goals to the user. In another embodiment, the financial goal visualization system provider device may retrieve information from one or more user accounts of the user, use that information to determine the plurality of financial goals that are personalized to the user, and at block 102 the device may send those financial goals over the network to a user device to provide the plurality of financial goals to the user. For example, the financial goal visualization system provider device may retrieve a plurality of financial data from a user's accounts to determine a past spending behavior of the user, and then use that past spending behavior of the user as a baseline for the user's projected spending behavior that may indicate one or more financial goals of the user. In some embodiments, reviews of the spending behavior of similar users or users with similar spending behavior may allow financial goals to be predetermined for a user.

In the examples provided below, the financial goals provided to the user include an education financial goal, a vacation financial goal, and a product financial goal, but the present disclosure is not limited to these examples, and a variety of financial goals know in the art will fall within its scope. Those financial goals may be the predetermined financial goals applicable to a variety of different users, or may be determined for a specific user from information retrieved from their user account (e.g., purchases for a child may indicate that an education financial goal is appropriate for the user, purchases associated with previous vacation spending may be used to determine a vacation financial goal appropriate for the user, product purchases older than a certain age may indicate that a product financial goal is appropriate for the user, etc.)

FIG. 2 illustrates a financial goal selection page 200 that may be displayed on a user device. The financial goal selection page 200 is illustrated, as well as other pages of the website of the illustrated embodiment, as being provided by a payment service provider and associated with a user account, but a variety of different providers may provide the financial goal selection page 200 and/or other pages of the website of the illustrated embodiment in a variety of different manners while remaining within the scope of the present disclosure. The financial goal selection page 200 includes a goal setting tab 202 that allows a user to create financial goal visualizations in a create section 204 of the goal setting tab 202. The create section 204 includes an education financial goal selector 206, a vacation financial goal selector 208, and a product financial goal selector 210.

Upon selection of one of the financial goal selectors 206, 208, or 210, the user may provide financial goal details for the determination of financial sub-goals (which are themselves financial goals) and/or financial goal statuses for the selected financial goal, associate images with those financial sub-goals and/or financial goal statuses, and receive savings plans for the selected financial goal and/or its sub-goals in blocks 104, 106, 108, 110, and 112 of the method 100. These blocks will be discussed below for each of a plurality of examples to illustrate how financial goal visualization may be provided for different financial goals, but as discussed with reference to block 114, 116, and 118, a plurality of financial goals may be visualized by a user simultaneously. Thus, while each of the financial goal visualization examples below is discussed as a separate embodiment of the method 100, each may be performed during the method 100 such that all of those financial goals may be visualized.

Referring now to FIGS. 1, 2, 3, and 4, the method 100 proceeds to block 104 where a selection of a financial goal is received by the financial goal visualization system provider device over the network from the user device. In this example, at block 104, the user has selected the education financial goal selector 206 to provide a selection of an education financial goal to the financial goal visualization system provider device over the network.

The method 100 then proceeds to block 106 where financial goal details for the selected financial goal are received. In an embodiment, upon user selection of a financial goal, the financial goal visualization system provider may request a plurality of information about the selected financial goal from the user, and the user may provide that information in order to provide financial goal details for the selected financial goal to the financial goal visualization system provider. For example, the financial goal visualization system provider device may provide a financial goal details page (not illustrated) over the network to the user device in response to the user selection of the education financial goal, that requests information from the user related to the number of children the user has, the schools to which the user wishes to send their children to, an amount already saved for the education financial goal(s) and/or a variety of other education financial goal details and/or other information that defines the education financial goal the user wishes to establish. The user then uses the user device to send these financial goal details over the network to the financial goal visualization system provider device.

The method 100 then proceeds to block 108 where a plurality of financial sub-goals may be determined for the selected financial goal. In an embodiment, using the financial goal details received in block 106, the financial goal visualization system provider device may determine a plurality of financial sub-goals for the financial goal selected in block 104. For example, for the education financial goal selected using the education financial goal selector 206, the financial goal visualization system provider device may determine a plurality of financial sub-goals that may include a high school education financial sub-goal such as an amount or range necessary for a child to attend a desired high school, a university education financial sub-goal such as an amount or range necessary for a child to attend a desired university, a two children education financial sub-goal such as an amount or range necessary for two children to complete their education, and/or a variety of other financial sub-goals related to the details of the user's education financial goal.

The method 100 then proceeds to block 110 where images are associated with the financial sub-goals. In an embodiment, the financial sub-goals determined in block 108 may be automatically associated with images for those financial sub-goals. For example, if a financial sub-goal for the education financial goal is associated with a desired high school or university, an image associated with that financial sub-goal may include an image of that high school or university that is provided or retrieved by the financial goal visualization system provider device, or an image associated with that high school or university (e.g., a sports mascot) that is provided or retrieved by the financial goal visualization system provider device. In another example, if a financial sub-goal for the education financial goal status is associated with a number of children to send to school, an image associated with that financial sub-goal may include an image of that number of students graduating that is provided or retrieved by the financial goal visualization system provider device. One of skill in the art will recognize that any financial sub-goal may be associated with any image that is appropriate in representing that financial sub-goal. In another embodiment, the user may provide and/or select images for association with the financial sub-goals determined in block 108.

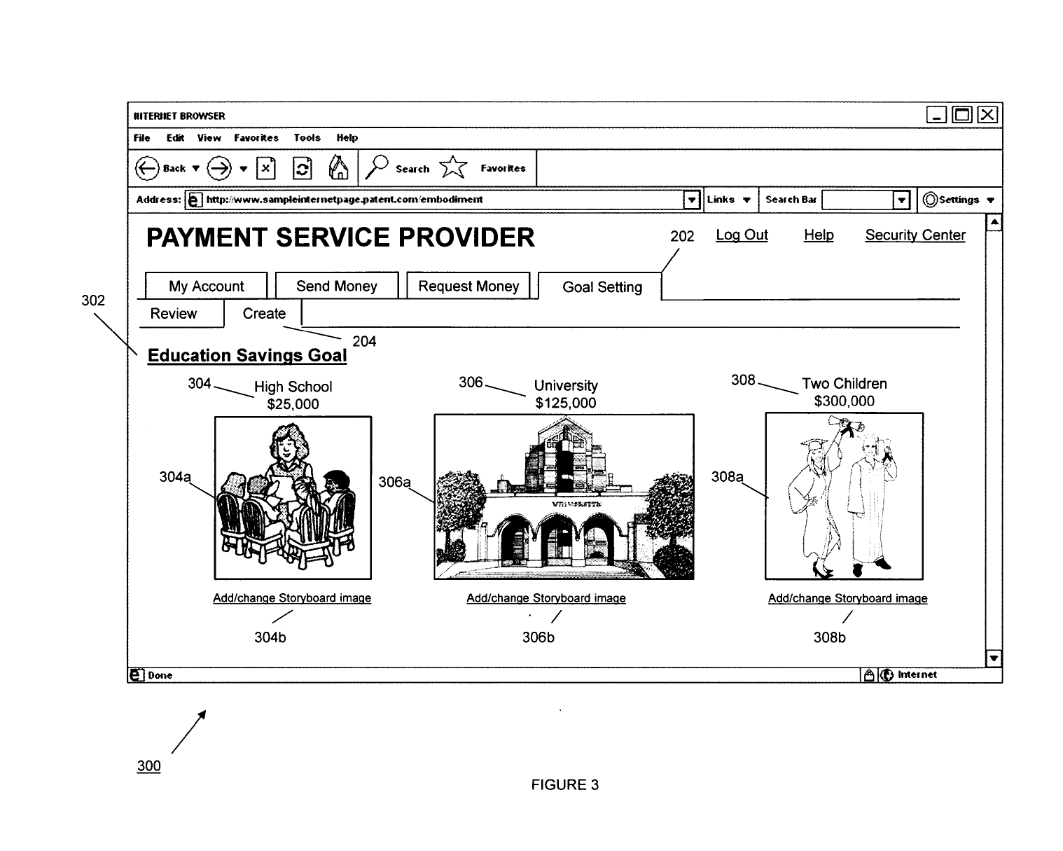

FIG. 3 illustrates an education financial goal visualization page 300 that has been provided by the financial goal visualization system provider device to the user device upon the user selection of the education financial goal selector 206, the provision of the financial goal details, the determination of the sub-goals, and the association of images with the financial sub-goals. The education financial goal visualization page 300 displays a plurality of financial sub-goals for an education financial goal 302, including a high school education financial sub-goal 304, a university education financial sub-goal 306, and a two children education financial sub-goal 308. In the illustrated embodiment, the high school education financial sub-goal 304 includes an amount necessary to send a child to a desired high school, a high school education image 304a associated with the high school education financial sub-goal 304, and an add/change image link 304b. In the illustrated embodiment, the university education financial sub-goal 306 includes an amount necessary to send a child to a desired university, a university education image 306a associated with the university education financial sub-goal 306, and an add/change image link 306b. In the illustrated embodiment, the two children education financial sub-goal 308 includes an amount necessary to educate two children, a two children education image 308a associated with the two children education financial sub-goal 308, and an add/change image link 308b.

The financial sub-goals 304, 306, and 308 on the education financial goal visualization page 300 may each be associated with a number of different images that each may be associated with a respective financial goal/sub-goal status (further referred to simply as a financial goal status with the understanding that it may reflect the status of a financial goal or sub-goal). For example, the high school education financial sub-goal 304 may include respective financial goal statuses for different savings amounts that correspond to different types of high schools that may require different amounts of money to attend (e.g., a first high school may require $10,000 to attend, a second high school may require $18,000 to attend, and a third high school may require $25,000 to attend), and each of those financial goal statuses may have an image associated with it (e.g., a first image associated with the first high school, a second image associated with the second high school, and a third image associated with the third high school). In another example, the university education financial sub-goal 304 may include financial goal statuses for different savings amounts that correspond to different types of universities that may require different amounts of money to attend (e.g., a first university may require $50,000 to attend, a second university may require $95,000 to attend, and a third university may require $125,000 to attend), and each of those financial goal statuses may have an image associated with it (e.g., a first image associated with the first university, a second image associated with the second university, and a third image associated with the third university). In another example, the two children education financial sub-goal 308 may include different images for the different levels of savings towards two children completing an education, including two students graduating (as illustrated), one student graduating, a student illustrated but not graduating, etc.

Furthermore, the education financial goal visualization page 300 may be personalized for the user. In an embodiment, the user (e.g., using the change/add image links 304b, 306b, and/or 308b) or the financial goal visualization system provider may add or change images associated with the high school education financial sub-goal 304, the university education financial sub-goal 306, and the two children education financial sub-goal 308. For example, the user may select or provide images for association with the different financial sub-goals discussed above (images of the high school, university, children, etc.) or financial goal statuses associated with those financial sub-goals. Furthermore, the user or financial goal visualization system provider may modify a first image provided for a first financial goal status of a first financial goal and associate that modified image with a second financial goal status of the first financial goal. For example, the two children education image 308a illustrated in FIG. 3 may be provided and associated with a full-goal-reached financial goal status of the two children education financial sub-goal 308 (i.e., a status that indicates enough money has been saved to send the two children all the way through desired schools), while a modified version of the two children education image 308a that erases one of the graduating students in the image may be provided and associated with a one-child-goal-reached financial goal status of the two children education financial sub-goal 308 (i.e., a status that indicates enough money has been saved to send one of the two children all the way through desired schools). While a specific example of an image modification to associate an image with a first financial goal status of a first financial goal and associate a modified version of the image with a second financial goal status of the first financial goal has been described, one of skill in the art will recognize that any modification to an image that provides a visualization of the different financial goal statuses associated with a financial goal will fall within the scope of the present disclosure.

In an embodiment, the financial goal visualization page 300 including the education financial goal 302 with education financial sub-goals 304, 306, and 308 and their associated images 304a, 306a, and 308a, may be a pre-populated storyboard that is auto created by the financial goal visualization system provider device based on the projected spending behavior of the user (retrieved from the user's accounts as discussed above) and known goals for users in similar financial situations. In such an embodiment, the user may then customize the storyboard as discussed above.

The method 100 then proceeds to block 112 where a savings plan for the selected financial goal and/or financial sub-goals is determined and provided to the user. In an embodiment, using the financial goal details provided at block 106, the financial goal visualization system provider device may calculate a savings plan for the education financial goal (e.g., one or more of the financial sub-goals determined at block 108.)

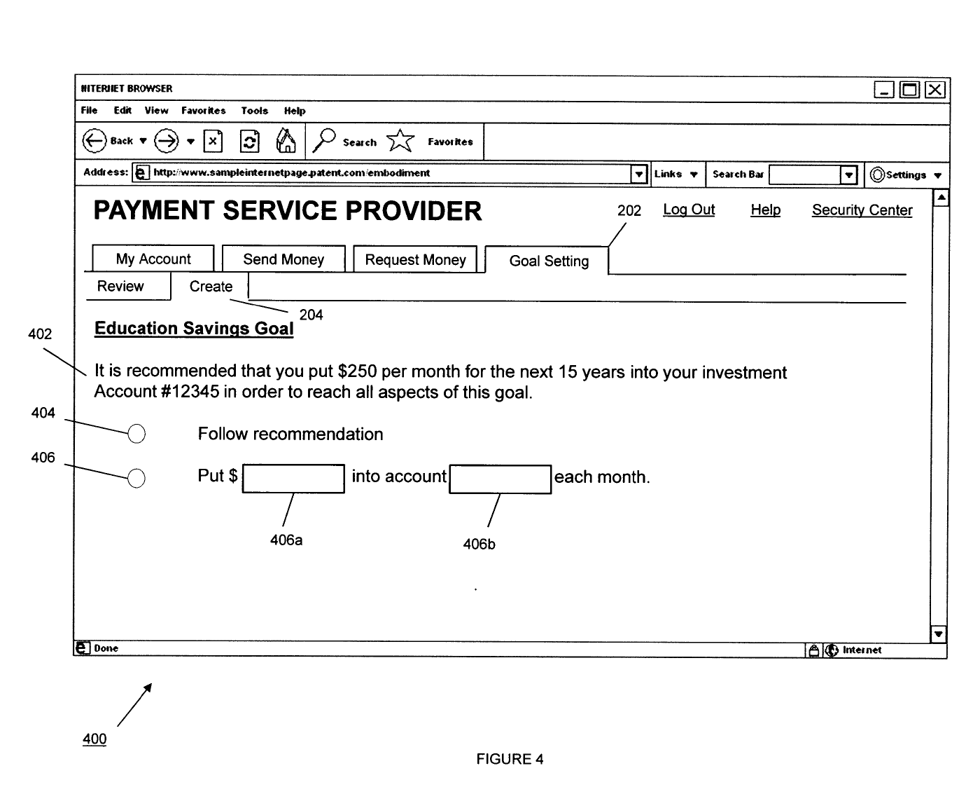

FIG. 4 illustrates an education financial goal savings plan page 400 that may be provided from the financial goal visualization system provider device to the user device upon the determination of the education financial goal savings plan. The education financial goal savings plan page 400 includes a recommended savings plan 402 that, in the illustrated embodiment, may include a savings plan to allow the user to send two children to the desired high school and desired university discussed above with reference to FIG. 3.

The education financial goal savings plan page 400 also includes a follow recommendation selector 404 and a modified savings plan selector 406 that is associated with a modified savings plan in which the user may input savings plan details for the modified savings plan in a plurality of inputs 406a and 406b to define how the user would like to save for the education financial goal and/or any of its sub-goals. Information associated with the recommended savings plan or the modified savings plan may be sent to the financial goal visualization system provider device depending on which of the follow recommendation selector 404 or the modified saving plan selector 406 is selected, and the financial goal visualization system provider device may save that information and/or associate it with a financial goal or sub-goal (e.g., such that savings on schedule with the savings plan selected on the education financial goal savings plan page 400 indicates to the financial goal visualization system provider device that the user is on track for the financial goal.) As discussed above, savings plans may be determined for the education financial goal as a whole, or for individual financial sub-goals.

In an embodiment, a selected or provided savings plan may be used by the financial goal visualization system provider to set up automatic transfers of money between user accounts in order to save for the financial goal as defined by the user according to the savings plan selected. In an embodiment, savings plans for a plurality of financial goals may be prioritized such that the financial goal visualization system provider may determine which of the plurality of financial goals to save for in the event there are limited funds in the user accounts.

Referring now to FIGS. 1, 2, 5, and 6, an example is provided of a vacation financial goal. In this example, at block 104, the user has selected the vacation financial goal selector 208 to provide a selection of a vacation financial goal to the financial goal visualization system provider device over the network.

The method 100 then proceeds to block 106 where financial goal details for the vacation financial goal are received. In this example, the financial goal visualization system provider device may provide a financial goal details page (not illustrated) over the network to the user device, in response to the user selection of the vacation financial goal, that requests information from the user related to the destination of the vacation, a desired airline for traveling, desired traveling accommodations, the length of the vacation, a desired hotel for the vacation, desired hotel accommodations for the vacation, the number of people going on the vacation, desired activities on the vacation, and/or a variety of other vacation financial goal details and/or other information that defines the vacation financial goal the user wishes to establish. The user then uses the user device to send these financial goal details over the network to the financial goal visualization system provider device.

The method 100 then proceeds to block 108 where a plurality of financial sub-goals may be determined for the vacation financial goal. In this example, for the vacation financial goal selected using the vacation financial goal selector 208, the financial goal visualization system provider device may determine a plurality of financial sub-goals that may include a plane tickets vacation financial sub-goal such as an amount or range necessary for the people going on the vacation to travel to the vacation destination on a desired airline, a hotel vacation financial sub-goal such as an amount or range necessary for the people going on the vacation to stay at the vacation destination at a desired hotel, an activities vacation financial sub-goal such as an amount or range necessary for the people going on the vacation to participate in desired activities, and/or a variety of other financial sub-goals related to the details of the user's vacation financial goal.

The method 100 then proceeds to block 110 where images are associated with the financial sub-goals. In this example, if a financial sub-goal for the vacation financial goal is associated with a desired airline or traveling accommodations, an image associated with that financial sub-goal may include an image of that desired airline that is provided or retrieved by the financial goal visualization system provider device, or an image of the desired traveling accommodations that is provided or retrieved by the financial goal visualization system provider device. In another example, if a financial sub-goal for the vacation financial goal is associated with a desired hotel or lodging accommodations, an image associated with that financial sub-goal may include an image of that desired hotel that is provided or retrieved by the financial goal visualization system provider device, or an image of the desired lodging accommodations that is provided or retrieved by the financial goal visualization system provider device. In another example, if a financial sub-goal for the vacation financial goal is associated with desired activities to participate in on the vacation, an image associated with that financial sub-goal may include an image of those activities that is provided or retrieved by the financial goal visualization system provider device. One of skill in the art will recognize that any financial sub-goal may be associated with any image that is appropriate in representing that financial sub-goal. In another embodiment, the user may provide and/or select images for association with the financial sub-goals determined in block 108.

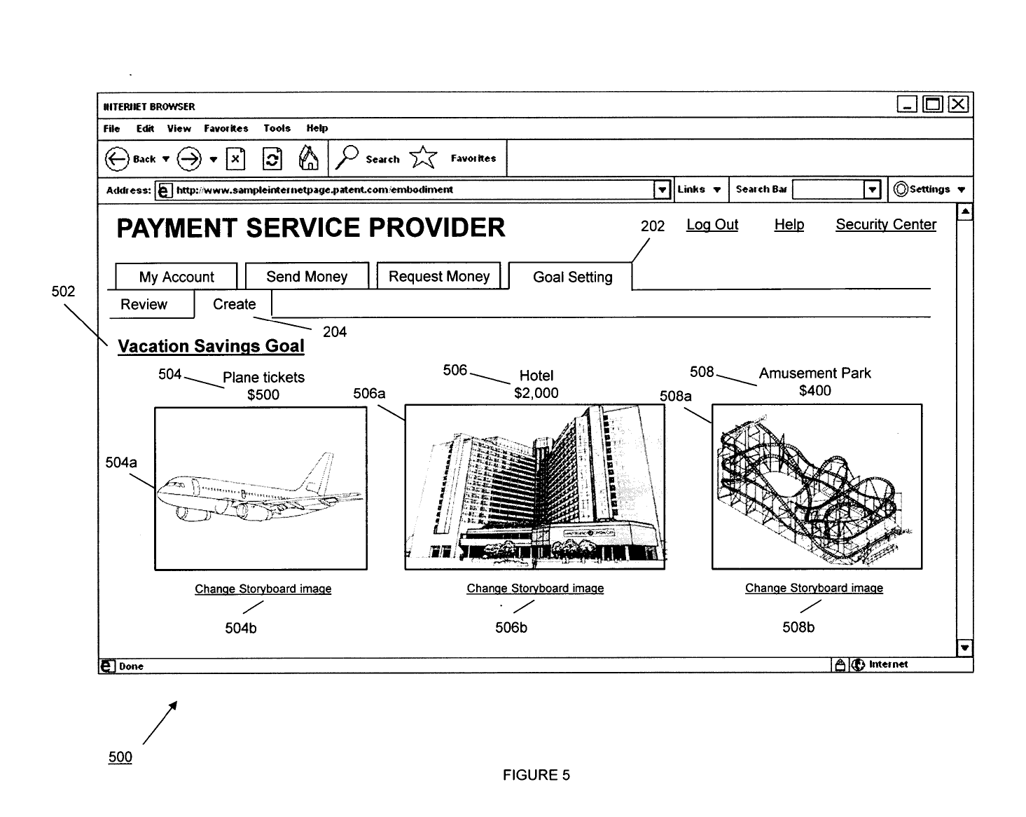

FIG. 5 illustrates a vacation financial goal visualization page 500 that has been provided by the financial goal visualization system provider device to the user device upon the user selection of the vacation financial goal selector 208, the provision of the financial goal details, the determination of the sub-goals, and the association of images with the financial sub-goals. The vacation financial goal visualization page 500 displays a plurality of financial sub-goals for a vacation financial goal 502, including a plane tickets vacation financial sub-goal 504, a hotel vacation financial sub-goal 506, and an activities vacation financial sub-goal 508. In the illustrated embodiment, the plane tickets vacation financial sub-goal 504 includes an amount necessary for the people going on the vacation to travel to the vacation destination on a desired airline using desired travel accommodations, a plane tickets vacation image 504a associated with the plane tickets vacation financial sub-goal 504, and an add/change image link 504b. In the illustrated embodiment, the hotel vacation financial sub-goal 506 includes an amount necessary for the people going on the vacation to stay at a desired hotel using desired lodging accommodations for the vacation duration, a hotel vacation image 506a associated with the hotel vacation financial sub-goal 506, and an add/change image link 506b. In the illustrated embodiment, the activities vacation financial sub-goal 508 includes an amount necessary for the people going on the vacation to participate in desired activities on the vacation, an activities vacation image 508a associated with the activities vacation financial sub-goal 508, and an add/change image link 508b.

The financial sub-goals 504, 506, and 508 on the vacation financial goal visualization page 500 may each be associated with a number of different images that each may be associated with a respective financial goal/sub-goal status (further referred to simply as a financial goal status with the understanding that it may reflect the status of a financial goal or sub-goal). For example, the planet ticket vacation financial sub-goal 504 may include respective financial goal statuses for different savings amounts that correspond to different airlines and/or different traveling accommodations (e.g., a first airline may cost more than a second airline that costs more than a third airline, first class traveling accommodations will cost more than business class traveling accommodations that will cost more than coach traveling accommodations, etc.), and each of those financial goal statuses may have an image associated with it (e.g., a first image associated with the first airline, a second image associated with the second airline, and a third image associated with the third airline, a first image associated with the first class traveling accommodations, a second image associated with the business class traveling accommodations, and a third image associated with the coach traveling accommodations). In another example, the hotel vacation financial sub-goal 504 may include financial goal statuses for different savings amounts that correspond to different hotels and/or different lodging accommodations (e.g., a first hotel may cost more than a second hotel that costs more than a third hotel, suite lodging accommodations will cost more than deluxe lodging accommodations that will cost more than standard lodging accommodations, etc.), and each of those financial goal statuses may have an image associated with it (e.g., a first image associated with the first hotel, a second image associated with the second hotel, and a third image associated with the third hotel, a first image associated with the suite lodging accommodations, a second image associated with the deluxe lodging accommodations, and a third image associated with the standard lodging accommodations). In another example, the activities vacation financial sub-goal 508 may include different images for different activities available to participate in during the vacation (e.g., an amusement park may cost more than a sightseeing tour that may cost more than a museum, etc.), and each of those financial goal statuses may have an image associated with it (e.g., a first image associated with the amusement park, a second image associated with the sightseeing tour, and a third image associated with the museum).

Furthermore, the vacation financial goal visualization page 500 may be personalized for the user. In an embodiment, the user (e.g., using the change/add image links 504b, 506b, and/or 508b) or the financial goal visualization system provider may add or change images associated with the plane ticket vacation financial sub-goal 504, the hotel vacation financial sub-goal 506, and the activities vacation financial sub-goal 508. For example, the user may select or provide images for association with the different financial sub-goals discussed above (images of the airlines, travel accommodations, hotels, lodging accommodations, activities, etc.) or financial goal statuses associated with those financial sub-goals.

In an embodiment, the financial goal visualization page 500 including the vacation financial goal 502 with vacation financial sub-goals 504, 506, and 508 and their associated images 504a, 506a, and 508a, may be a pre-populated storyboard that is auto created by the financial goal visualization system provider device based on the projected spending behavior of the user (retrieved from the user's accounts as discussed above) and known goals for users in similar financial situations. In such an embodiment, the user may then customize the storyboard as discussed above.

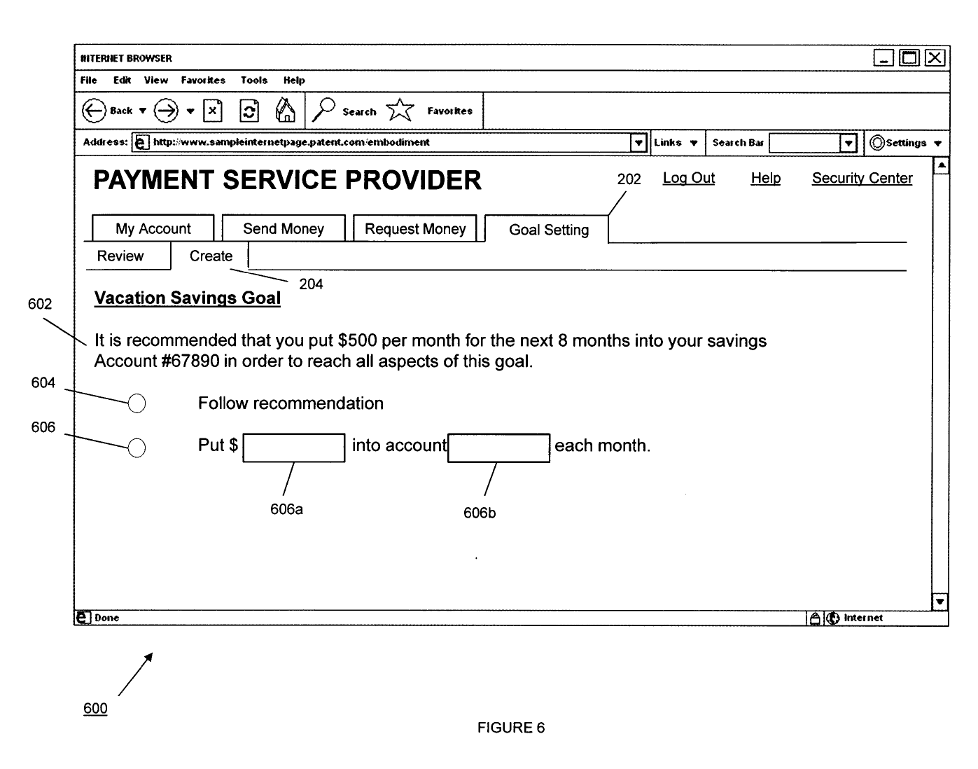

The method 100 then proceeds to block 112 where a savings plan for the selected financial goal and/or financial sub-goals is determined and provided to the user. In an embodiment, using the financial goal details provided at block 106, the financial goal visualization system provider device may calculate a savings plan for the vacation financial goal (e.g., one or more of the financial sub-goals determined at block 108.) FIG. 6 illustrates a vacation financial goal savings plan page 600 that may be provided from the financial goal visualization provider device to the user device upon the determination of the vacation financial goal savings plan. The education financial goal savings plan page 600 includes a recommended savings plan 602 that, in the illustrated embodiment, may include a savings plan to allow the user to pay for a desired number of people to go on a vacation that includes traveling on a desired airline using the desired traveling accommodations, stay in a desired hotel using the desired lodging accommodations, and participate in desired activities, discussed above with reference to FIG. 5.

The vacation financial goal savings plan page 600 also includes a follow recommendation selector 604 and a modified savings plan selector 606 that is associated with a modified savings plan in which the user may input savings plan details for the modified savings plan in a plurality of inputs 606a and 606b to define how the user would like to save for the vacation financial goal and/or any of its sub-goals. Information associated with the recommended savings plan or the modified savings plan may be sent to the financial goal visualization system provider device depending on which of the follow recommendation selector 604 or the modified saving plan selector 606 is selected, and the financial goal visualization system provider device may save that information and/or associate it with a financial goal or sub-goal (e.g., such that savings on schedule with the savings plan selected on the vacation financial goal savings plan page 600 indicates to the financial goal visualization system provider device that the user is on track for the financial goal.) As discussed above, savings plans may be determined for the vacation financial goal as a whole, or for individual financial sub-goals.

In an embodiment, a selected or provided savings plan may be used by the financial goal visualization system provider to set up automatic transfers of money between user accounts in order to save for the financial goal as defined by the user according to the savings plan selected. In an embodiment, savings plans for a plurality of financial goals may be prioritized such that the financial goal visualization system provider may determine which of the plurality of financial goals to save for in the event there are limited funds in the user accounts.

Referring now to FIGS. 1, 2, 7, and 8, an example is provided of a product financial goal. In this example, at block 104, the user has selected the product financial goal selector 210 to provide a selection of product financial goal to the financial goal visualization system provider device over the network.

The method 100 then proceeds to block 106 where financial goal details for the product financial goal are received. In this example, the financial goal visualization system provider device may provide a financial goal details page (not illustrated) over the network to the user device, in response to the user selection of the product financial goal, that requests information from the user related to product such as make, model, features, and/or a variety of other product financial goal details and/or other information that defines the product financial goal the user wishes to establish. The user then uses the user device to send these financial goal details over the network to the financial goal visualization system provider device.

The method 100 then proceeds to block 108 where a plurality of financial sub-goals may be determined for the product financial goal. In this example, for the product financial goal selected using the product goal selector 210, the financial goal visualization system provider device may determine a plurality of financial sub-goals that may include a first product model financial sub-goal such as a model or type of the product that costs a first amount or range, a second product model financial sub-goal such as a model or type of the product that costs a second amount or range that is greater than the first amount or range, and a third product model financial sub-goal such as a model or type of the product that costs a third amount or range that is greater than the first amount or range and the second amount or range, and/or a variety of other financial sub-goals related to the details of the user's product financial goal.

The method 100 then proceeds to block 110 where images are associated with the financial sub-goals. In this example, if a financial sub-goal for the product financial goal is associated with a television, an image associated with the financial sub-goal may include respective images of the first model product, the second model product, and the third model product. One of skill in the art will recognize that any financial sub-goal may be associated with any image that is appropriate in representing that financial sub-goal. In another embodiment, the user may provide and/or select images for association with the financial sub-goals determined in block 108.

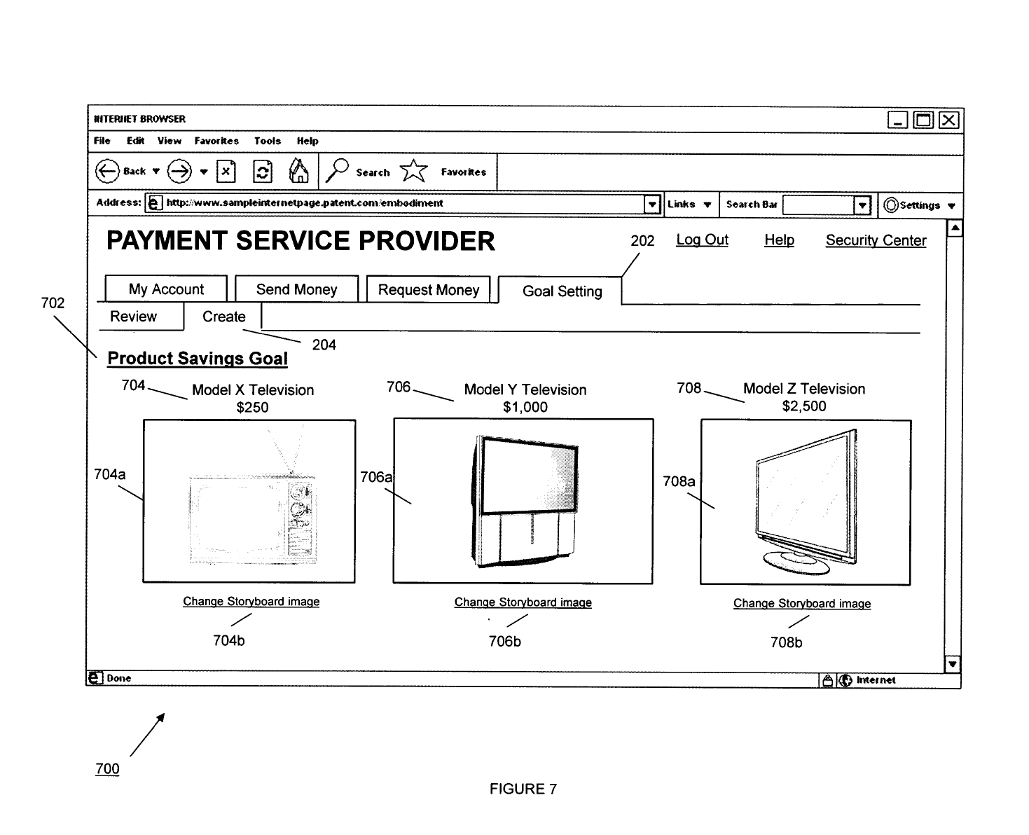

FIG. 7 illustrates a product financial goal visualization page 700 that has been provided by the financial goal visualization system provider device to the user device upon the user selection of the product financial goal selector 210, the provision of the financial goal details, the determination of the sub-goals, and the association of images with the financial sub-goals. The product financial goal visualization page 700 displays a plurality of financial sub-goals for a product financial goal 702, including a first model product financial sub-goal 704, a second model product financial sub-goal 706, and a third model product financial sub-goal 708. In the illustrated embodiment, the first model product financial sub-goal 704 includes a first amount necessary to buy the first model product, a first model product image 704a associated with the first model product financial sub-goal 704, and an add/change image link 704b. In the illustrated embodiment, the second model product financial sub-goal 706 includes a second amount necessary to buy the second model product, a second model product image 706a associated with the second model product financial sub-goal 706, and an add/change image link 706b. In the illustrated embodiment, the third model product financial sub-goal 708 includes a third amount necessary to buy the third model product, third model product image 708a associated with the third model product financial sub-goal 708, and an add/change image link 708b.

In this example, the financial sub-goals 704, 706, and 708 on the product financial goal visualization page 700 may each be considered different financial goal statuses of the product financial goal. For example, the first model product financial sub-goal 704 corresponds to a low financial goal status for the product financial goal 702 that will allow the user to purchase the lowest model version of the desired product (a television in the illustrated embodiment), the second model product financial sub-goal 706 corresponds to a medium financial goal status for the product financial goal 702 that will allow the user to purchase a medium model version of the television, and the third model product financial sub-goal 708 corresponds to a high financial goal status for the product financial goal 702 that will allow the user to purchase the highest model version of the television.

Furthermore, the product financial goal visualization page 700 may be personalized for the user. In an embodiment, the user (e.g., using the change/add image links 704b, 706b, and/or 708b) or the financial goal visualization system provider may add or change images associated with the first model product financial sub-goal 704, the second model product financial sub-goal 706, and the third model product financial sub-goal 708. For example, the user may select or provide images for association with the different financial sub-goals discussed above (e.g., images of the different model products, etc.).

In an embodiment, the financial goal visualization page 700 including the product financial goal 702 with product financial sub-goals 704, 706, and 708 and their associated images 704a, 706a, and 708a, may be a pre-populated storyboard that is auto created by the financial goal visualization system provider device based on the projected spending behavior of the user (retrieved from the user's accounts as discussed above) and known goals for users in similar financial situations. In such an embodiment, the user may then customize the storyboard as discussed above.

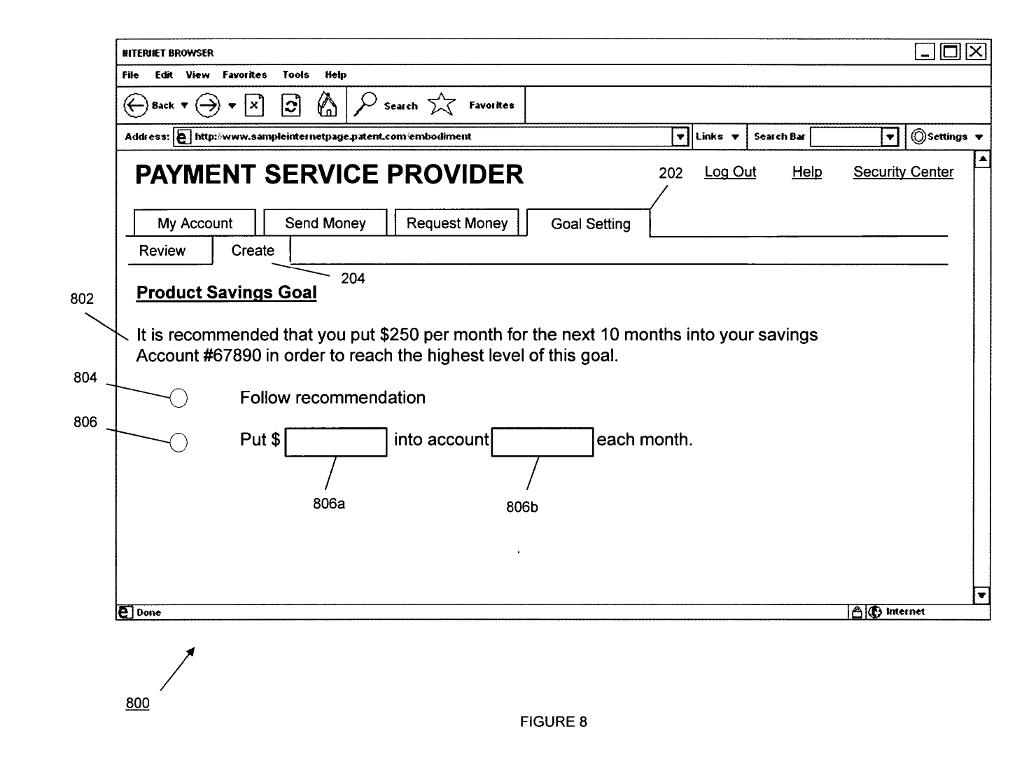

The method 100 then proceeds to block 112 where a savings plan for the selected financial goal and/or financial sub-goals is determined and provided to the user. In an embodiment, using the financial goal details provided at block 106, the financial goal visualization system provider device may calculate a savings plan for the product financial goal (e.g., one or more of the financial sub-goals determined at block 108.) FIG. 8 illustrates a product financial goal savings plan page 800 that may be provided from the financial goal visualization provider device to the user device upon the determination of the product financial goal savings plan. The product financial goal savings plan page 800 includes a recommended savings plan 802 that, in the illustrated embodiment, may include a savings plan to allow the user to pay for a desired model of the product having the desired features.

The product financial goal savings plan page 800 also includes a follow recommendation selector 804 and a modified savings plan selector 806 that is associated with a modified savings plan in which the user may input savings plan details for the modified savings plan in a plurality of inputs 806a and 806b to define how the user would like to save for the product financial goal and/or any of its sub-goals. Information associated with the recommended savings plan or the modified savings plan may be sent to the financial goal visualization system provider device depending on which of the follow recommendation selector 804 or the modified saving plan selector 806 is selected, and the financial goal visualization system provider device may save that information and/or associate it with a financial goal or sub-goal (e.g., such that savings on schedule with the savings plan selected on the product financial goal savings plan page 800 indicates to the financial goal visualization system provider device that the user is on track for the financial goal.)

In an embodiment, a selected or provided savings plan may be used by the financial goal visualization system provider to set up automatic transfers of money between user accounts in order to save for the financial goal as defined by the user according to the savings plan selected. In an embodiment, savings plans for a plurality of financial goals may be prioritized such that the financial goal visualization system provider may determine which of the plurality of financial goals to save for in the event there are limited funds in the user accounts.

As discussed above, a plurality of different financial goals may be defined by the user similarly to the examples provided. In an embodiment, the user may prioritize financial goals relative to each other such that the financial goal visualization system provider may determine financial goal statuses of those financial goals, calculate savings plans for the different financial goals, etc.

The method 100 then proceeds to block 114 where financial data of the user is retrieved. As discussed above, the financial goal visualization system provider device will have access to one or more user accounts that are associated with the financial goals provided in the method 100. For example, the user accounts may include a plurality of financial accounts such as, for example, a checking account, a savings account, an investment account, and/or a variety of other financial accounts, in which the user saves money for the financial goals, and the financial goal visualization provider device will have access to the financial details of those user financial accounts. At block 114, the financial goal visualization system provider device retrieves financial data from the one or more user accounts over the network from, for example, associated account provider devices.

The method 100 then proceeds to block 116 where a financial goal status is determined using the financial data. Using the financial data retrieved from one or more of the user accounts in block 114, the financial goal visualization system provider device may determine a financial goal status for one or more of the financial goals defined in the method 100. For example, the financial goal visualization system provider device may compare money in an investment account (and/or other accounts) to the education financial goal and/or its high school education financial sub-goal, university education financial sub-goal, and/or two children education financial sub-goal, and determine a status of that financial goal and/or sub-goals. In another example, the financial goal visualization system provider device may compare money in a savings account (and/or other accounts) to the vacation financial goal and/or its plane ticket vacation financial sub-goal, hotel vacation financial sub-goal, and/or activities vacation financial sub-goal, and determine a status of that financial goal and/or sub-goals. In another example, the financial goal visualization system provider device may compare money in a savings account (and/or other accounts) to the product financial goal and determine a status of that financial goal with respect to its first model product financial sub-goal, second model product financial sub-goal, and third model product financial sub-goal. Financial goal statuses are indicative of the progress a user has made towards their respective financial goals, as described below.

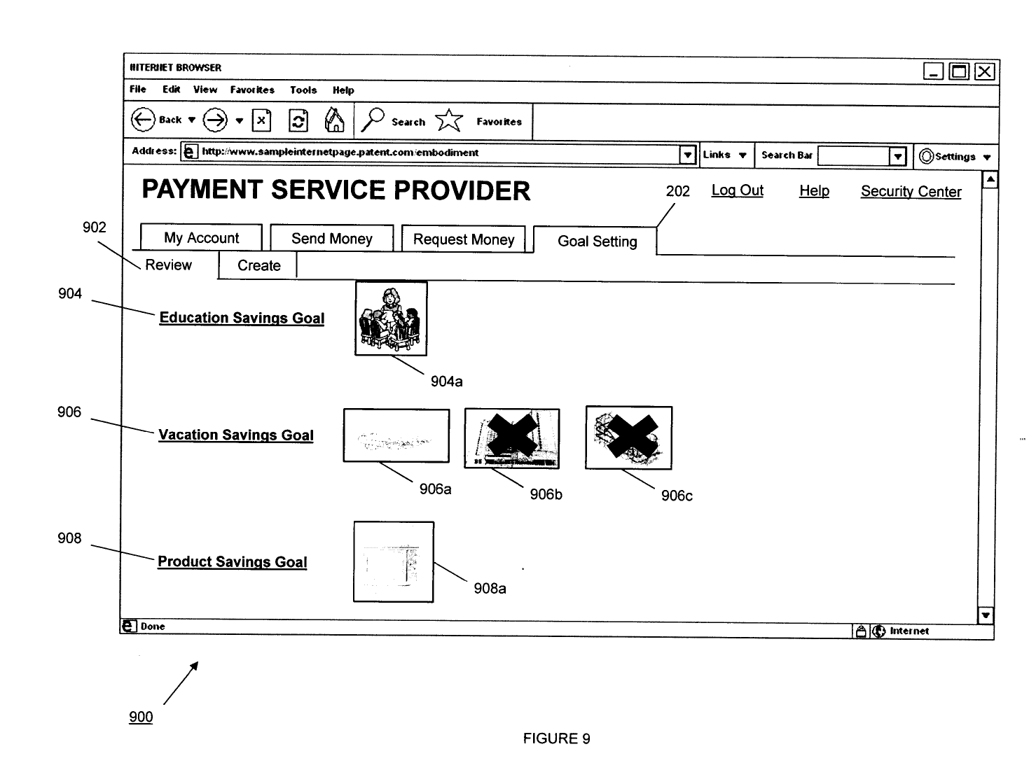

The method 100 then proceeds to block 118 where images associated with the determined financial statuses of the financial goals are provided for display to the user. In an embodiment, the user may use the user device to access a financial goal progress page (e.g., over the network and provided by the financial goal visualization system provider device) in order to receive a visualization of their financial goals, and that may result in the retrieval of the financial data at block 114, the determination of the financial goal status(es) at block 116, and the provision of the images at block 118. FIGS. 9, 10, and 11 provide examples of financial goal progress pages that allow a user to visualize their financial goals as defined in the method 100, but such examples should not be limiting, as a variety of different financial goal visualization is envisioned as falling within the scope of the present disclosure.

FIG. 9 illustrates a financial goal progress page 900 displaying the financial goal review section 902 of the goal setting tab 202 discussed above. The financial goal progress page 900 includes the education financial goal 904, discussed above with reference to FIGS. 3 and 4, with an education financial goal image 904a that was retrieved and provided based on the financial goal status determined at block 116. In the illustrated embodiment, the education financial goal image 904a includes a high school education image that indicates to the user that they have saved enough money to send a desired number of children to a desired high school. However, the financial goal status may also indicate that the user has not saved enough money to send a desired number of children to a desired university, resulting in no image related to a university education financial sub-goal (e.g., the university education financial sub-goal 306 in FIG. 3). In a related example, if the user had not saved enough money for a desired number of children to attend a desired high school, the education financial goal image 904a could include a different image (e.g., a high school different from the desired high school that the user's current savings could afford for the desired number of children.) Furthermore, images may visually “fill up” (e.g., portions of the image may be visible based on a percentage of the amount saved towards achieving their related financial goal), may be bordered (e.g., a border may be provided or colored around the image based on a percentage of the amount saved towards achieving the related financial goal), and/or a variety of visual cues may be provided such that the image indicates to the user their progress towards the financial goal. Thus, from a look at the financial goal progress page 900, the user can quickly visualize their progress towards the education financial goal as defined during the method 100.

The financial goal progress page 900 also includes the vacation financial goal 906, discussed above with reference to FIGS. 5 and 6, with a plurality of vacation financial goal images 906a, 906b, and 906c that were retrieved, provided, and in some cases modified, based on the financial goal status determined at block 116. In the illustrated embodiment, the vacation financial goal images 906a, 906b, and 906c include a plane ticket vacation image that indicates to the user that they have saved enough money for a desired number of people to travel on a desired airline using desired travel accommodations. However, the financial goal status may also indicate that the user has not saved enough money for the desired number of people to stay in a desired hotel using desired lodging accommodations for the vacation duration, and the user has not saved enough money for the desired number of people to participate in desired activities during the vacation, resulting in vacation financial goal image 906b (e.g., associated with the hotel vacation financial sub-goal 506 in FIG. 3) and vacation financial goal image 906c (e.g., associated with the activities vacation financial sub-goal 508 in FIG. 3) being “crossed out”. In a related example, if the user had not saved enough money for a desired number of people to travel on the desired airline using the desired travel accommodations, the vacation financial goal image 906a could include a different image (e.g., an airline different from the desired airline that the users current savings could afford for the desired number of people, travel accommodations different from the desired travel accommodations that the users current savings could afford for the desired number of people, etc.) Furthermore, while the financial images associated with the financial goals which have not been achieved yet are illustrated as being crossed out, other visual indications of the users failure to be on track for the financial goal may be provided such as, for example, visually removing the image by providing an animation of the image being moved into a trash can icon. Similarly, when the user gets back on track for that financial goal, that image may be removed from the trash can icon. Thus, from a look at the financial goal progress page 900, the user can quickly visualize their progress towards the vacation financial goal as defined during the method 100.

The financial goal progress page 900 also includes the product financial goal 908, discussed above with reference to FIGS. 7 and 8, with a product financial goal image 908a that was retrieved and provided based on the financial goal status determined at block 116. In the illustrated embodiment, the product financial goal image 908a includes a first model product image that indicates to the user that they have saved enough money for a first model of a desired type of product. However, the financial goal status may also indicate that the user has not saved enough money for the desired model of the desired type of product, and thus an image associated with that desired model is not displayed. Thus, from a look at the financial goal progress page 900, the user can quickly visualize their progress towards the product financial goal as defined during the method 100.

In addition to providing the financial goal progress page 900, the financial goal visualization system provider device may recalculate spending plans for the financial goals, and provide them to the user similarly as discussed above, such that the that the user may get back on track for all their financial goals by accepting the savings plans and having them implemented with regard to their user accounts. In an embodiment, failure to accept a recalculated savings plan may result in an image associated with a financial goal (e.g., the lowest priority financial goal for which the user is not on track for) being removed or otherwise used to indicate to the user that they will not reach that financial goal (e.g., moving the product financial goal image 908a into a trash can icon.)

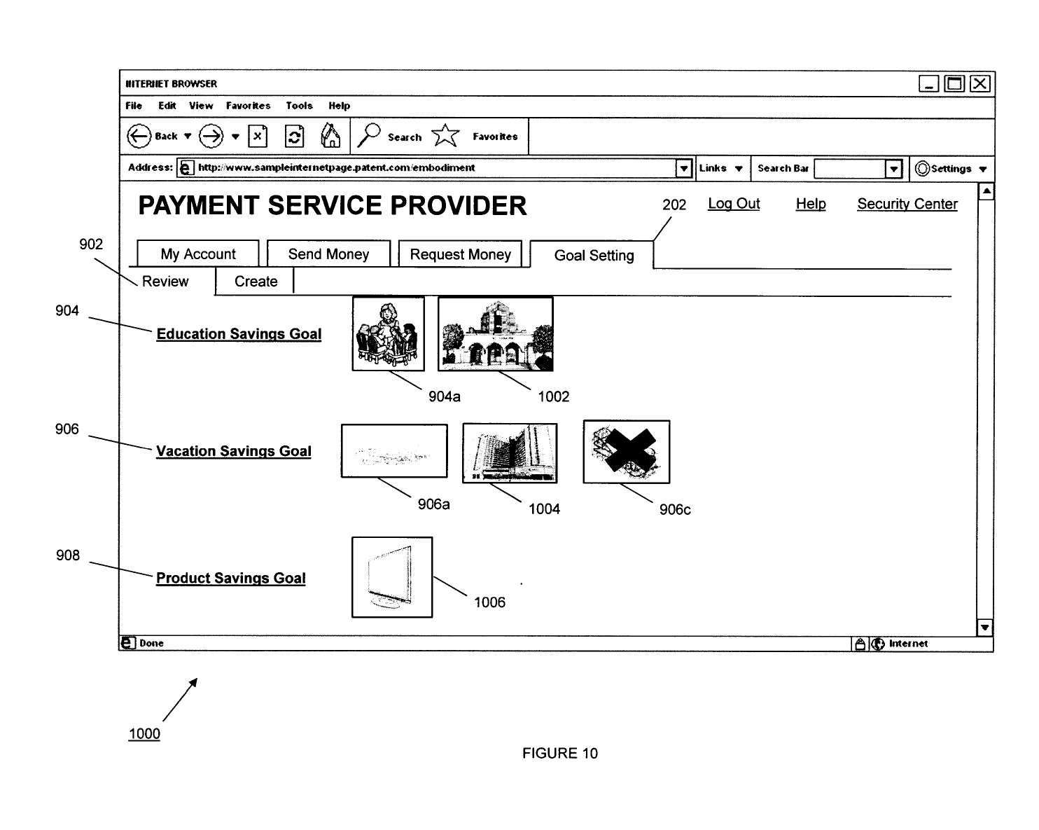

FIG. 10 illustrates an updated financial goal progress page 1000 that may be provided by the financial goal visualization system provider device after the provision of the financial goal progress page 900 and subsequent retrieval of new financial data from the user accounts and determination of new financial goal statuses for the financial goals. The updated financial goal progress page displays the financial goal review section 902 of the goal setting tab 202 discussed above with reference to the financial goal progress page 900, but with some modifications. The updated financial goal progress page 1000 may be provided by the financial goal visualization system provider device to the user device over the network after the provision of the financial goal progress page 900 and then subsequent savings activities of the user. The updated financial goal progress page 1000 includes the education financial goal 904 with the education financial goal image 904a along with an education financial goal image 1002 that were retrieved and provided based on the new financial goal status. In the illustrated embodiment, the education financial goal images 904a and 1002 include a high school education image that indicates to the user that they have saved enough money to send a desired number of children to a desired high school, and a university education image that indicates to the user that they have saved enough money to send a desired number of children to a desired university. However, the new financial goal status could also indicate that the user has used up saved money that previously allowed the user to send a desired number of children to the desired high school, which would result in the high school education image 904a (and the university image 1002) being removed from the education financial goal 904. Thus, from a look at the updated financial goal progress page 1000, the user can quickly visualize their updated progress towards the education financial goal as defined during the method 100 (e.g., the user has now saved enough money to put the desired number of children through a desired high school and a desired university.) In a related example, if the user had not saved enough money for a desired number of children to attend a desired university, the education financial goal image 1002 could include a different image (e.g., a university different from the desired university that the users current savings could afford for the desired number of children.)

The updated financial goal progress page 1000 also includes the vacation financial goal 906 with the plurality of vacation financial goal images 904a and 904c along with a vacation financial goal image 1004 that were retrieved and provided based on the new financial goal status. In the illustrated embodiment, the vacation financial goal images 906a, 1004, and 906c include a plane ticket vacation image that indicates to the user that they have saved enough money for a desired number of people to travel on a desired airline using desired travel accommodations, and a hotel vacation image that indicates to the user that they have saved enough money for a desired number of people to stay at a desired hotel using desired lodging accommodations. However, the financial goal status may also indicate that the user has not saved enough money for the desired number of people to participate in desired activities on the vacation, resulting in the vacation financial goal image 906c (e.g., associated with the activities vacation financial sub-goal 508 in FIG. 3) still being “crossed out”. Thus, from a look at the updated financial goal progress page 1000, the user can quickly visualize their updated progress towards the vacation financial goal as defined during the method 100 (e.g., the user has now saved enough money to take the desired number of people on vacation in a desired airline using desired travel accommodations and stay at a desired hotel using desired lodging accommodations.) In a related example, if the user had not saved enough money for a desired number of people to stay in the desired hotel using the desired lodging accommodations, the vacation financial goal image 1004 could include a different image (e.g., a hotel different from the desired hotel that the users current savings could afford for the desired number of people, lodging accommodations different from the lodging accommodations that the users current savings could afford for the desired number of people, etc.)

The updated financial goal progress page 1000 also includes the product financial goal 908 with a product financial goal image 1006 that was retrieved and provided based on the financial goal status determined at block 116. In the illustrated embodiment, the product financial goal image 1006 was retrieved based on a financial goal status and includes a third model product image that indicates to the user that they have saved enough money for a desired model of the desired product. Thus, from a look at the financial goal progress page 900, the user can quickly visualize their updated progress towards the product financial goal as defined during the method 100 (e.g., the use has now saved enough money to afford the desired product (a high model television).)

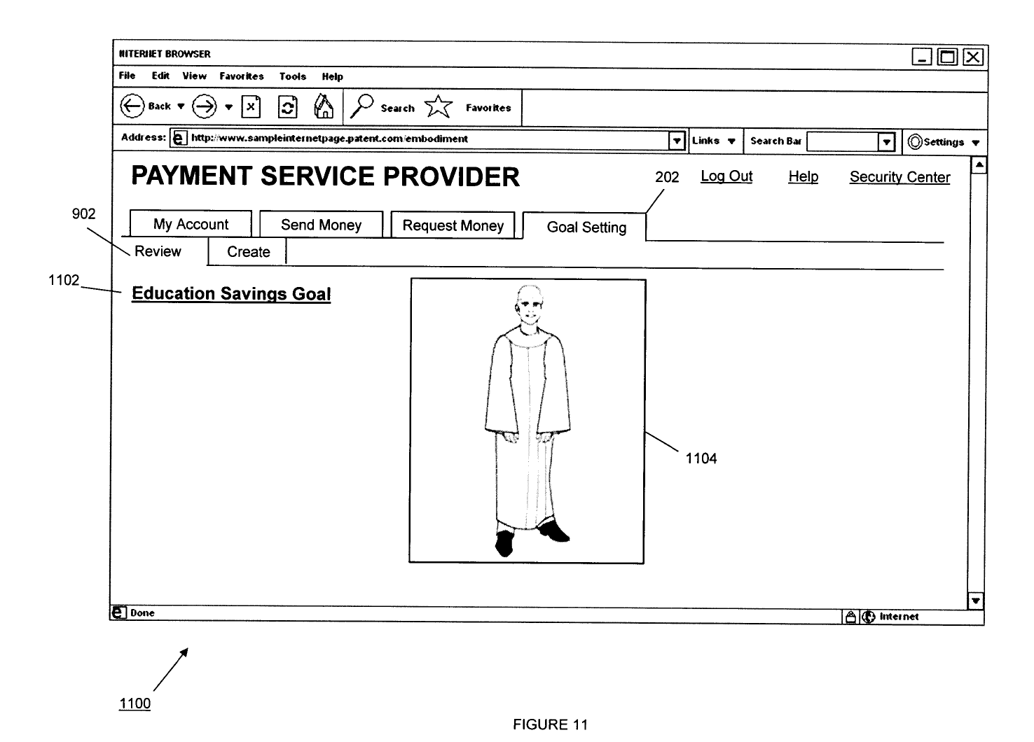

FIG. 11 illustrates a financial goal progress page 1100 having a modified image to allow a user to visualize a financial goal. The financial goal progress page 1100 may be provided by the financial goal visualization system provider device to the user device after the retrieval of financial data from the user accounts and determination of financial goal statuses for the financial goals. The financial goal progress page 1100 displays the financial goal review section 902 of the goal setting tab 202 discussed above with reference to the financial goal progress page 900, but with some modifications. The financial goal progress page 1100 includes a modified education financial goal image 1104 that is associated with a second financial goal status and that has been modified from an original education financial goal image that is associated with a first financial goal status. For example, the modified education financial goal image 1104 may have been created by modifying the two children education financial goal image 308a that is associated with the two children education financial sub-goal 308, discussed above with reference to FIG. 3. As can be seen in FIG. 3, the two children education financial goal image 308a includes two students graduating, while the modified education financial goal image 1104 is a modified version of the two children education financial goal image 308a with one of the students removed and the other student no longer wearing a graduation cap or holding a diploma. In an embodiment, in response to retrieving financial data from the user accounts and determining that the financial data corresponds to a financial goal status that does not allow either child to attend a desired high school or university, the modified education financial goal image 1104 may be provided on the financial goal progress page 1100 to indicate to the user that their progress towards the two children education financial sub-goal 308.

Any number of modifications to an image may be made (e.g., by the financial goal visualization system provider and/or the user) and those modified images associated with different financial goal statuses of a financial goal in order to provide images that are indicative to the user of the associated financial goal status. For example, different levels of savings may result in the provision of different modified images such as the modified image modified education financial goal image 1104 discussed above with the user has not saved enough money to send either child to a desired high school or university, a modified education financial goal image that includes one of the students in the two children education image 308a when the user has saved enough money to send one child to a desired high school and a desired university, and the two children education image 308a when the user has saved enough money to send both children to a desired high school and a desired university.

Thus, a system and method for visualizing a financial goal has been described that associates images with financial goals and financial goal statuses, periodically checks financial data of accounts associated with those financial goals, and then displays images according to the financial goal status determined using the financial data so that the user may easily visualize their progress towards financial goals. While a plurality of a examples of financial goals and images have been provided above, they are not meant to be limiting, and other financial goals and media associated with those financial goals may be used to allow a user to determine their progress towards their financial goals. For example, audio, video, animations, and/or other media may be associated with financial goals and financial goal statuses similarly as discussed above for images, and that media may be provided similarly as discussed above for images to indicate the user's progress towards their financial goal.

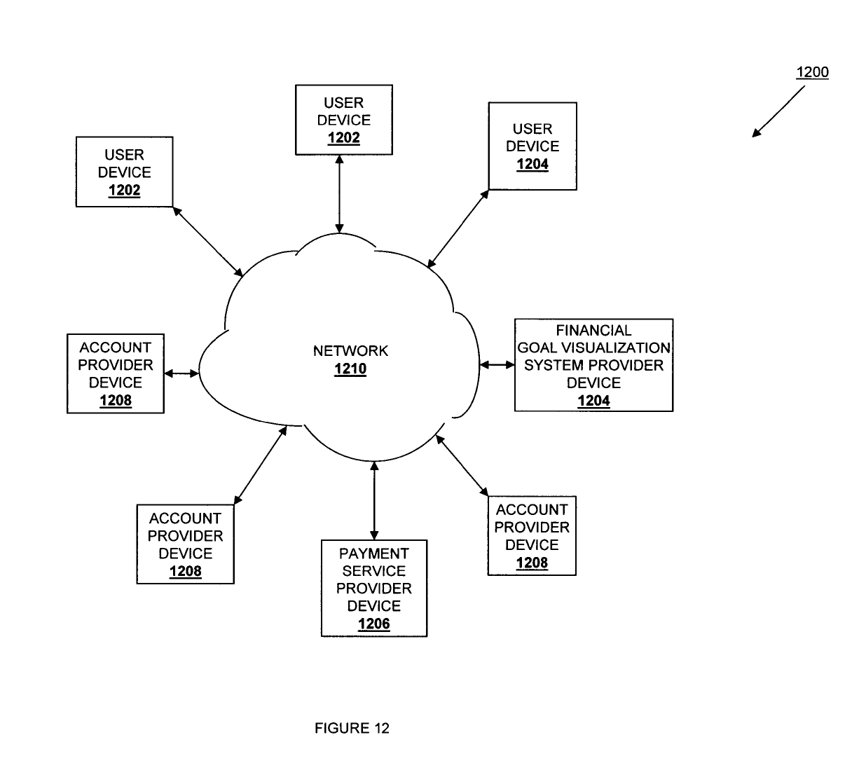

Referring now to FIG. 12, an embodiment of a networked system 1200 used in the financial goal visualization system described above is illustrated. The networked system 1200 includes a plurality of user devices 1202, a financial goal visualization system provider device 1204, a payment service provider device 1206, and/or a plurality of account holder devices 1208 in communication over a network 1210. Any of the user devices 1202 may be the user device discussed above. The financial goal visualization system provider device 1204 may be the financial goal visualization system provider device discussed above and may be operated by the financial goal visualization system provider, the account providers, and/or the payment service provider discussed above. The payment service provider device 1206 may be the payment service provider devices discussed above and may be operated by a payment service provider such as, for example, PayPal Inc. of San Jose, Calif. The account provider devices 1208 may be the account provider devices discussed above and may be operated by the account providers discussed above such as, for example, credit card account providers, bank account providers, savings account providers, and a variety of other account providers known in the art.

The user devices 1202, financial goal visualization system provider device 1204, payment service provider device 1206, and account provider devices 1208 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1200, and/or accessible over the network 1210.

The network 1210 may be implemented as a single network or a combination of multiple networks. For example, in various embodiments, the network 1210 may include the

Internet and/or one or more intranets, landline networks, wireless networks, and/or other appropriate types of networks.

The user device 1202 may be implemented using any appropriate combination of hardware and/or software configured for wired and/or wireless communication over network 1210. For example, in one embodiment, the user device 1202 may be implemented as a personal computer of a user in communication with the Internet. In other embodiments, the user device 1202 may be a smart phone, personal digital assistant (PDA), laptop computer, and/or other types of computing devices.

The user device 1202 may include one or more browser applications which may be used, for example, to provide a convenient interface to permit the user to browse information available over the network 1210. For example, in one embodiment, the browser application may be implemented as a web browser configured to view information available over the Internet.

The user device 1202 may also include one or more toolbar applications which may be used, for example, to provide user-side processing for performing desired tasks in response to operations selected by the user. In one embodiment, the toolbar application may display a user interface in connection with the browser application.

The user device 1202 may further include other applications as may be desired in particular embodiments to provide desired features to the user device 1202. In particular, the other applications may include a payment application for payments assisted by a payment service provider through the payment service provider device 1206. The other applications may also include security applications for implementing user-side security features, programmatic user applications for interfacing with appropriate application programming interfaces (APIs) over the network 1210, or other types of applications. Email and/or text applications may also be included, which allow the user to send and receive emails and/or text messages through the network 1210. The user device 1202 includes one or more user and/or device identifiers which may be implemented, for example, as operating system registry entries, cookies associated with the browser application, identifiers associated with hardware of the user device 1202, or other appropriate identifiers, such as a phone number. In one embodiment, the user identifier may be used by the financial goal visualization system provider device 1204, the payment service provider device 1206, and/or the account provider device 1208 to associate the user with a particular account as further described herein.

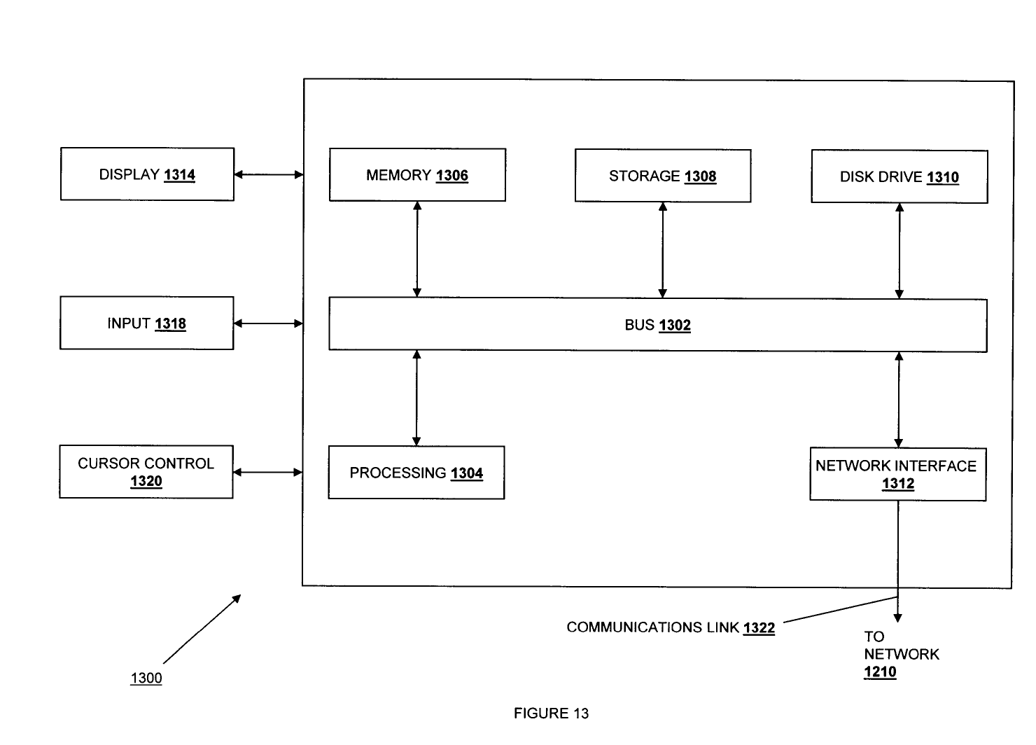

Referring now to FIG. 13, an embodiment of a computer system 1300 suitable for implementing, for example, the user device 1202, the financial goal visualization system provider device 1204, the payment service provider device 1206, and/or the account provider device 1208, is illustrated. It should be appreciated that other devices utilized by users, financial goal visualization system providers, payment service providers, and account providers in the payment system discussed above may be implemented as the computer system 1300 in a manner as follows.

In accordance with various embodiments of the present disclosure, computer system 1300, such as a computer and/or a network server, includes a bus 1302 or other communication mechanism for communicating information, which interconnects subsystems and components, such as a processing component 1304 (e.g., processor, micro-controller, digital signal processor (DSP), etc.), a system memory component 1306 (e.g., RAM), a static storage component 1308 (e.g., ROM), a disk drive component 1310 (e.g., magnetic or optical), a network interface component 1312 (e.g., modem or Ethernet card), a display component 1314 (e.g., CRT or LCD), an input component 1318 (e.g., keyboard, keypad, or virtual keyboard), and/or a cursor control component 1320 (e.g., mouse, pointer, or trackball). In one implementation, the disk drive component 1310 may comprise a database having one or more disk drive components.

In accordance with embodiments of the present disclosure, the computer system 1300 performs specific operations by the processor 1304 executing one or more sequences of instructions contained in the memory component 1306, such as described herein with respect to the user device 1202, the financial goal visualization system provider device 1204, the payment service provider device 1206, and/or the account provider device(s) 1208. Such instructions may be read into the system memory component 1306 from another computer readable medium, such as the static storage component 1308 or the disk drive component 1310. In other embodiments, hard-wired circuitry may be used in place of or in combination with software instructions to implement the present disclosure.

Logic may be encoded in a computer readable medium, which may refer to any medium that participates in providing instructions to the processor 1304 for execution. Such a medium may take many forms, including but not limited to, non-volatile media, volatile media, and transmission media. In many embodiments, the computer readable medium is non-transitory. In various implementations, non-volatile media includes optical or magnetic disks, such as the disk drive component 1310, volatile media includes dynamic memory, such as the system memory component 1306, and transmission media includes coaxial cables, copper wire, and fiber optics, including wires that comprise the bus 1302. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by the computer system 1300. In various other embodiments of the present disclosure, a plurality of the computer systems 1300 coupled by a communication link 1324 to the network 1210 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1300 may transmit and receive messages, data, information and instructions, including one or more programs (i.e., application code) through the communication link 1324 and the network interface component 1312. The network interface component 1312 may include an antenna, either separate or integrated, to enable transmission and reception via the communication link 1324. Received program code may be executed by processor 1304 as received and/or stored in disk drive component 1310 or some other non-volatile storage component for execution.

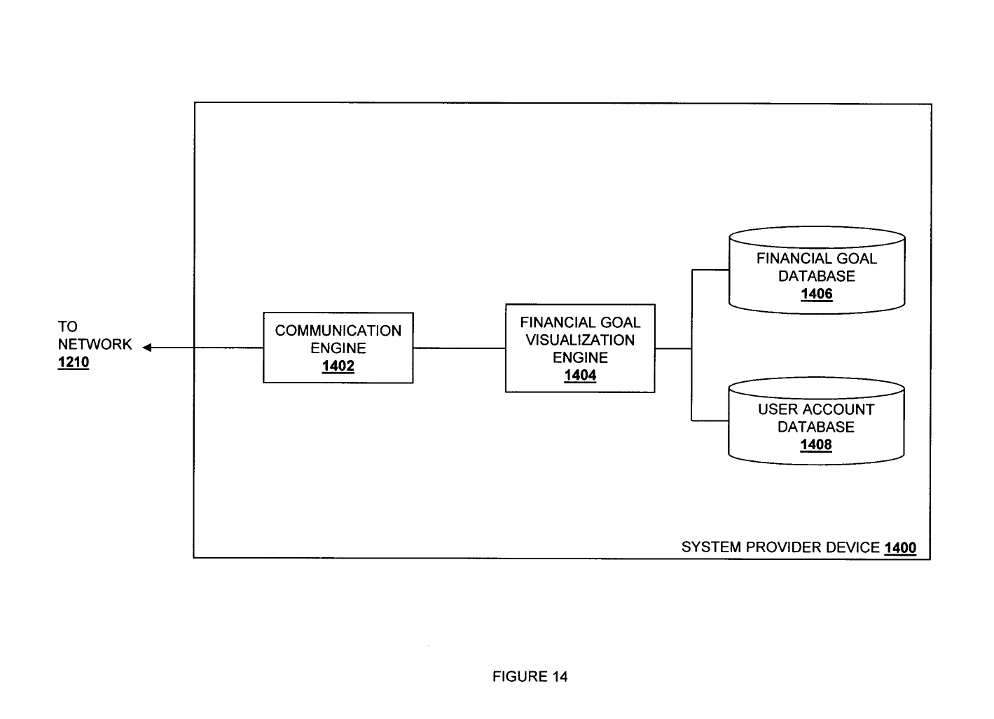

Referring now to FIGS. 14, an embodiment of a financial goal visualization system provider device 1400 is illustrated. In an embodiment, the device 1400 may be the payer the payment service provider device 1206 and/or the account holder device 1208. The device 1400 includes a communication engine 1402 that is coupled to the network 1210 and to an financial goal visualization engine 1404 that is coupled to a financial goal database 1406 and a user account database 1408. The communication engine 1402 may be software or instructions stored on a computer-readable medium that allows the device 1400 to send and receive information over the network 1210. The financial goal visualization engine 1404 may be software or instructions stored on a computer-readable medium that is operable to determine financial goals using financial data in user accounts in the user account database 1408, receive financial goals, receive financial goal details, determine financial goal statuses of financial goals, associate the financial goals and/or financial goal statuses with images in the financial goal database 1406, retrieve financial data from user accounts in the user account database 1408, provide images associated with determined financial goals statuses to a user device, calculate savings plans for financial goals, modify images and associate those modified images with financial goals and financial goal statuses, and provide any of the other functionality that is discussed above. While the databases 1406 and 1408 has been illustrated as located in the device 1400, one of skill in the art will recognize that either or both may be connected to the financial goal visualization engine 1404 through the network 1210 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A financial goal visualization system, comprising:
at least one non-transitory memory storing a plurality of financial goals and a plurality of images;
one or more hardware processors coupled to the at least one memory and operable to read instructions from the at least one memory to perform the steps of:
receiving a selection from a user of a first financial goal from the plurality of financial goals, wherein the first financial goal includes a plurality of financial sub-goals;
associating at least one of the plurality of images with each of the financial sub-goals of the first financial goal such that a different image is associated with each of the plurality of financial sub-goals of the first financial goal;
retrieving a plurality of first financial data from at least one user account of the user;
determining a first financial goal status for each of the financial sub-goals of the first financial goal using the first financial data; and
providing an image for each financial sub-goal of the first financial goal based on the first financial goal status in order to display a storyboard having a plurality of images for visualizing progress related to the first financial goal.

2. The system of claim 1, wherein the one or more processors are operable to read instructions from the memory to perform the steps of:
determining the plurality of financial goals using the at least one user account of the user;
providing the plurality of financial goals for display to the user, wherein the first financial goal received from the user is selected from the plurality of financial goals displayed to the user.

3. The system of claim 1, wherein the one or more processors are operable to read instructions from the memory to perform the steps of:
receiving from a user at least one financial goal detail;
determining the plurality of financial sub-goals for the first financial goal using the at least one financial goal detail;
associating a subset of the plurality of images with each of the plurality of financial sub-goals; and
providing at least one of images in the subset of the plurality of images that are associated with each financial sub-goal over the network for display.

4. The system of claim 1, wherein the one or more processors are operable to read instructions from the memory to perform the steps of:
retrieving a plurality of second financial data from the at least one user account of the user;
determining a second financial goal status using the second financial data; and
providing an image for each financial sub-goal of the first financial goal based on the second financial goal status in order to display a storyboard having a plurality of images for visualizing progress related to the first financial goal.

5. The system of claim 4, wherein a first image associated with the first financial goal status of a first financial sub-goal of the first financial goal includes a first image that is modified to provide a second image that is associated with a second financial goal status of the first financial sub-goal of the first financial goal.

6. The system of claim 1, wherein at least one of the images is received from the user.

7. A method for visualizing a financial goal, comprising:
receiving a selection of a financial goal from a user device of a user over a network, wherein the financial goal includes a plurality of financial sub-goals;
associating at least one of a plurality of images with each of the financial sub-goals of the financial goal in a database such that a different image is associated with each of the plurality of financial sub-goals of the financial goal;
retrieving a plurality of first financial data from at least one user account of the user;
determining a first financial goal status for each of the financial sub-goals of the financial goal using the first financial data; and
providing an image for each financial sub-goal of the financial goal based on the first financial goal status in order to display a storyboard having a plurality of images for visualizing progress related to the first financial goal on a display device.

8. The method of claim 7, further comprising:
determining a plurality of financial goals using the at least one user account of the user;
providing the plurality of financial goals over the network for display on the user device, wherein the financial goal received from the user device is selected from the plurality of financial goals displayed on the user device.

9. The method of claim 7, further comprising:
receiving at least one financial goal detail from the user device over the network;
determining the plurality of financial sub-goals for the financial goal using the at least one financial goal detail;
associating a subset of the plurality of images with each of the plurality of financial sub-goals; and
providing at least one of the images in the subset of the plurality of images that are associated with each financial sub-goal over the network for display on a display device.

10. The method of claim 9, further comprising:
calculating a savings plan for at least one financial sub-goal of the financial goal using the at least one financial goal detail; and
providing the savings plans for the at least one financial sub-goal of the financial goal over the network to the user device.

11. The method of claim 7, further comprising:
retrieving a plurality of second financial data from the at least one user account of the user;
determining a second financial goal status using the second financial data; and
providing an image for each financial sub-goal of the financial goal based on the second financial goal status in order to display a storyboard having a plurality of images for visualizing progress related to the financial goal on a display device.

12. The method of claim 11, wherein a first image associated with the first financial goal status of a first financial sub-goal of the financial goal includes a first image that is modified to provide a second image that is associated with a second financial goal status of the first financial sub-goal of the first financial goal.

13. The method of claim 7, wherein at least one of the images is received from the user device over the network.

14. A non-transitory machine-readable medium comprising a plurality of machine-readable instructions which, when executed by one or more processors, are adapted to cause the one or more processors to perform a method comprising:
receiving a selection of a plurality of financial goals from a user device of a user over a network, wherein each of the plurality of financial goals includes a plurality of financial sub-goals;
associating at least one of a plurality of images with each of the financial sub-goals for each of the plurality of financial goals in a database such that a different image is associated with each financial sub-goal of each of the plurality of financial goals;
retrieving a plurality of first financial data from at least one user account of the user;
determining a first financial goal status for each of the financial sub-goals of each of the plurality of financial goals using the first financial data; and
providing an image for each financial sub-goal of each of the plurality of financial goals based on the first financial goal status in order to display a storyboard having a plurality of images for visualizing progress related to the plurality of financial goals on a display device.

15. The non-transitory machine-readable medium of claim 14, wherein the method further comprises:
determining the plurality of financial goals using the at least one user account of the user;
providing the plurality of financial goals over the network for display on the user device.

16. The non-transitory machine-readable medium of claim 14, wherein the method further comprises:
receiving at least one financial goal detail for each of the plurality of financial goals from the user device over the network;
determining the plurality of financial sub-goals for each of the plurality of financial goals using the at least one financial goal detail received for that financial goal;
associating a subset of the plurality of images with each of the plurality of financial sub-goals of the plurality of financial goals; and
providing at least one of the images in the subset of the plurality of images that are associated with each financial sub-goal for each of the plurality of financial goals over the network for display on a display device.

17. The non-transitory machine-readable medium of claim 16, wherein the method further comprises:
calculating a savings plan for each of the financial sub-goals of the plurality of financial goals using the at least one financial goal detail received for that financial goal; and
providing the savings plans for each of the financial sub-goals of the plurality of financial goals over the network to the user device.

18. The non-transitory machine-readable medium of claim 14, wherein the method further comprises:
retrieving a plurality of second financial data from the at least one user account of the user;
determining a second financial goal status for each of the financial sub-goals of the plurality of financial goals using the second financial data; and
providing an image for each of the plurality of financial sub-goals of the plurality of financial goals based on the second financial goal status in order to display a storyboard having a plurality of images for visualizing progress related to the plurality of financial goals on a display device.

19. The non-transitory machine-readable medium of claim 18, wherein a first image associated with the first financial goal status of a first financial sub-goal of a first financial goal includes a first image that is modified to provide a second image that is associated with a second financial goal status of the first financial sub-goal of the first financial goal.

20. The non-transitory machine-readable medium of claim 14, wherein at least one of the images is received from the user device over the network.
